(19) United States
(12) Patent Application Publication
(10) Pub. No.: US 2020/0165080 A1
(43) Pub. Date: May 28, 2020

(54) MACHINE AND METHOD FOR UNSTACKING CONTAINERS

(71) Applicant: ALIMEC S.R.L., Valli del Pasubio (IT)

(72) Inventor: Roso Urbano, Schio (IT)

(21) Appl. No.: 16/633,625

(22) PCT Filed: Jul. 27, 2017
(86) PCT No.: PCT/IT2017/000158

§ 371 Date: Jan. 24, 2020

(51) Int. Cl. B65G 59/10

(52) U.S. Cl. CPC B65G 59/106

(57) ABSTRACT

A machine and a method for unstacking containers are described, the containers being preferably non-rigid and configured to contain food products. The machine includes pickup elements, hollow inside, disposed between a plurality of vertical loading cylinders and a horizontal conveyor belt. The pickup elements are vertically mobile between a first operating position, in which they are facing toward the loading cylinders, but distant from them, and a second operating position in which they are at least partly inserted in the loading cylinders and in contact with each of the containers that is temporarily at the bottom of the corresponding stack, and vice versa. A suction device is in fluidic communication with the pickup elements to temporarily constrain to them, by air suction, each container that is temporarily at the bottom of the corresponding stack.

### FIELD OF THE INVENTION

The field of application of the present invention is that of the automatic processing of containers, preferably non-rigid and configured to contain food products. The containers, without limitation to the generality, can be both ramekins, cups and tubs, in their most varied shapes and sizes, and are made of different materials such as for example paper, cardboard, plastic materials, or silicone materials. More particularly, the present invention concerns a machine and a method for unstacking said containers, selectively and in a programmed manner, from one or more predefined stacks, preferably vertical, and to automatically position them on an underlying support, for example directly on a horizontal conveyor belt or on trays or any suitable support mean provided with seatings to receive the containers to be transported to a subsequent processing step.

### BACKGROUND OF THE INVENTION

Unstacking machines are known, also called “denesters” in English, which are used when there is a need to remove containers of any shape and size, one at a time, from a corresponding stack. A particular field where such unstacking machines are used is that of the food industry.

In particular, this field comprises handling non-rigid containers configured to contain food products, such as for example ramekins, cups, or tubs, in their most varied shapes and sizes, cylindrical, truncated cone, parallelepiped, and suchlike, and made of different materials, such as paper, with one or more sheets, cardboard, or plastic materials.

Known unstacking machines are normally provided with a pickup device configured to both selectively pick up the container positioned at the bottom of each stack, and also to transfer each container picked up to a suitable seating of a transport member, for example a conveyor belt, normally underneath each stack of containers, and configured to transport the containers to a subsequent processing step, in which the desired food products can be inserted into the containers.

In known unstacking machines, the stacks of containers are generally disposed inside loaders inclined by a certain angle, for example comprised between 30° and 60°, with respect to the transport member.

Known unstacking machines are, however, quite complex, not very flexible and very expensive.

Another disadvantage of known unstacking machines is that the pickup device is not able to pick up the containers from the respective loaders. Indeed, the fact that the containers are made of non-rigid materials and that they are disposed inside inclined loaders causes them to sometimes offer resistance to the pickup device during the pickup step, for example getting stuck and blocked in the loader.

Furthermore, in known unstacking machines, the pickup device can typically comprise one or more suction cups.

The presence of the suction cups has several disadvantages.

First of all, it should be considered that unstacking machines normally operate in the field of automatic processing lines for packaging semi-solid products, such as for example doughs for confectionery. These are therefore environments where food powders can be present, such as sugars or flours.

One disadvantage of the pickup devices known in the state of the art is that powders suspended in the atmosphere can deposit on the suction cups of the pickup devices. This dirties the surface of the suction cups that comes into contact with the containers and causes problems with hygiene and cleaning the machine.

Another disadvantage of pickup devices known in the state of the art is that the suction cups completely deform the containers, that is, both the bottom wall and also the lateral walls. This is particularly undesirable because the lateral walls can remain deformed even after the containers have been filled with the intended product. In fact, the weight force of the dough, weighing on the bottom wall, can allow the latter to resume its original shape but is not able to force the lateral walls to return to the non-deformed position.

A first purpose of the present invention is to overcome the disadvantages of prior art unstacking machines, by obtaining a machine and by perfecting the corresponding method for unstacking containers from one or more stacks, said containers being preferably made of non-rigid materials such as for example paper, with one or more sheets, cardboard, or plastic materials, and intended, for example, to contain food products, which is simple, reliable, and which allows to obtain a high production capacity, expressed in the number of operations or cycles per minute.

Another purpose of the present invention is to obtain an unstacking machine and to perfect the corresponding method, which is also versatile and can therefore treat the different types of format of said containers, that is, for example and without limitation to the generality, ramekins, cups, or tubs, in their most varied shapes and sizes, for example cylindrical, truncated cone, parallelepiped and others.

Another purpose of the present invention is to obtain an unstacking machine and to perfect the corresponding method in which the containers can be picked up effectively from the respective loaders.

The Applicant has devised, tested and embodied the machine and perfected the method for the automatic treating of containers according to the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, a machine for unstacking containers, preferably non-rigid and configured to contain food products according to the present invention, comprises loading means configured to contain inside them the containers stacked one on top of the other, with their bottom facing upward, and receiving means, which can comprise, for example, a conveyor belt, or a tray, provided with suitable seatings for the containers, in order to receive the latter after they have been picked up from the loading means.

According to one characteristic of the present invention, the machine also comprises pickup means disposed between the loading means and the receiving means and configured to move vertically at least between a first operating position, in which they are facing toward the containers, but distant from them, and a second operating position in which they are at least partly inserted in the loading means and in contact with each of the containers that is temporarily at the bottom of the corresponding stack, and vice versa. First movement means are configured to selectively move the pickup means at least between said two operating positions, and suction means are associated with the pickup means and are configured to be activated when the pickup means are in the second operating position in order to temporarily constrain to the pickup means, by means of air suction, each of the containers that is temporarily at the bottom of the corresponding stack. Moreover, second movement means are configured to take the pickup means from the first operating position to a third operating position, in which the latter are rotated by about 180° and facing toward the receiving means in order to position on the latter the containers picked up from the loading means by the pickup means.

According to another characteristic of the present invention, the loading means comprise a determinate number of loading cylinders, substantially vertical and with a determinate spatial disposition. Moreover, the pickup means comprise a number of pickup elements equal to the number of the loading means and with the same spatial disposition as the latter.

According to another characteristic of the present invention, when the containers have a truncated cone shape flared toward the outside, each loading cylinder has an internal diameter bigger than the maximum diameter of each container and is provided both with a flared lower surface, against which the container that is at the bottom of the stack can temporarily rest, and also with a lower central aperture with a diameter at least slightly bigger than the diameter of the bottom of each container.

According to another characteristic of the present invention, each pickup element comprises an axially hollow cylinder in fluidic communication with the suction means.

According to another characteristic of the present invention, each axially hollow cylinder has an external diameter slightly smaller than the diameter of the lower central aperture of the corresponding loading cylinder.

According to another characteristic of the present invention, each axially hollow cylinder is provided with one or more upper and/or lateral orifices, which put the internal cavity of each cylinder into communication with the outside.

According to another characteristic of the present invention, each pickup element is removably assembled on a shaft connected both to the first movement means and also to the second movement means, so that it can be both translated parallel to its axis of rotation, and also rotated with respect to the latter.

According to another characteristic of the present invention, a method for unstacking containers, preferably non-rigid and configured to contain food products, by means of a machine with loading means configured to contain inside them the containers stacked one on top of the other, with their bottom facing upward, and receiving means configured to receive the containers after they have been picked up from the loading means, in which pickup means disposed between the loading means and the receiving means are first raised vertically by first movement means from a first operating position, in which the pickup means are facing toward the containers but distant from the latter, to a second operating position in which the pickup means are at least partly inserted in the loading means and in contact with each of the containers that is temporarily at the bottom of the corresponding stack, after which suction means associated with the pickup means are activated to temporarily constrain to the pickup means, by means of air suction, each of the containers that is temporarily at the bottom of the corresponding stack, and then the pickup means are returned to the first operating position together with the containers associated therewith by the suction means that remain activated, and also a positioning step in which second movement means take the pickup means from the first operating position to a third operating position, in which they are rotated by about 180° and facing toward the receiving means in order to position on the latter the containers picked up from the loading means by means of the pickup means.

According to another characteristic of the present invention, said positioning step comprises a blowing step during which blowing means, by means of the pickup means, blow air toward the corresponding containers associated with the latter in order to detach them from them.

For example, the above mentioned suction and blowing means can consist of a single suction and blowing device.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a plan view of a machine for unstacking containers, preferably non-rigid for food products, according to the present invention;

FIG. 2 is a front view of the machine in FIG. 1;

FIG. 3 is an enlarged detail of the machine in FIG. 2, with some sectioned parts;

FIG. 4 is a schematic view of a detail of the machine in FIG. 1 in a first operating position;

FIG. 5 is a schematic view of the detail of FIG. 4 in a second operating position, after a first operating step;

FIG. 6 is a schematic view of the detail of FIG. 4 once again in the first operating position, after a second and a third operating step;

FIG. 7 is a schematic view of the detail of FIG. 4 in a third operating position, after a fourth operating step;

FIG. 8 is a schematic view of the detail of FIG. 4 in a fourth operating position, after a fifth and a sixth operating step;

FIG. 9 is a schematic view of the detail of FIG. 4 once again in the third operating position, after a seventh operating step.

We must clarify that in the present description and claims, the sole function of the terms horizontal, vertical, lower, upper, internal, external, above and below, with their dependent forms, is to better show the present invention with reference to the drawings and must in no way be used to limit the scope of the invention, or the field of protection defined by the claims.

### DETAILED DESCRIPTION OF SOME EMBODIMENTS

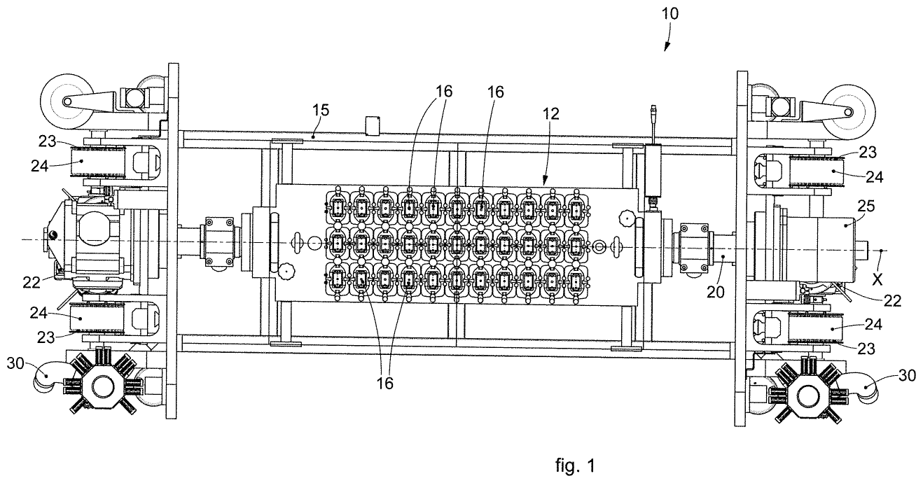

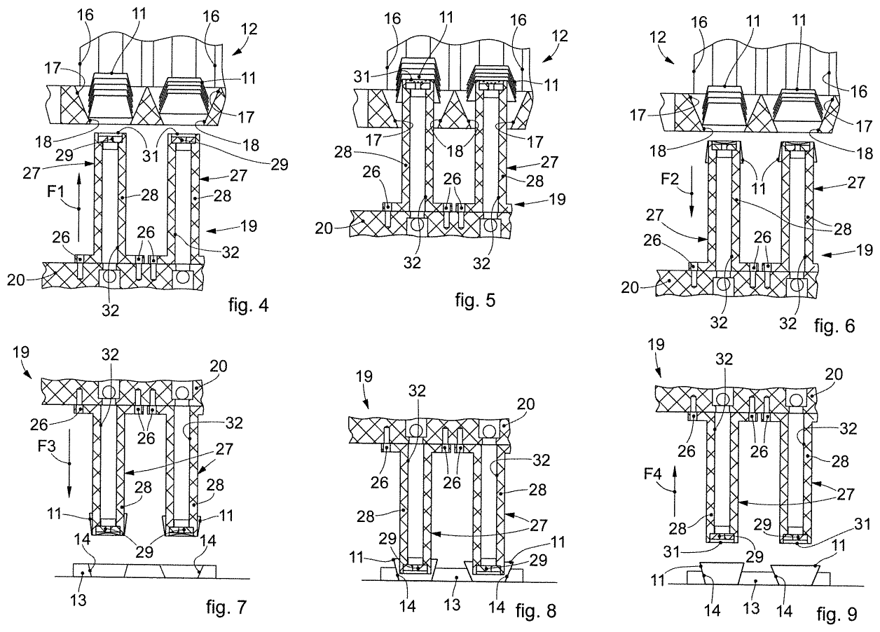

With reference to FIG. 1, a machine 10 according to the present invention is configured to automatically unstack a plurality of containers 11 (FIGS. 4 to 9), preferably of a non-rigid type, suitable to contain food products and stacked in a loading store 12 (FIGS. 1 to 3), and to selectively position them on suitable receiving means 13.

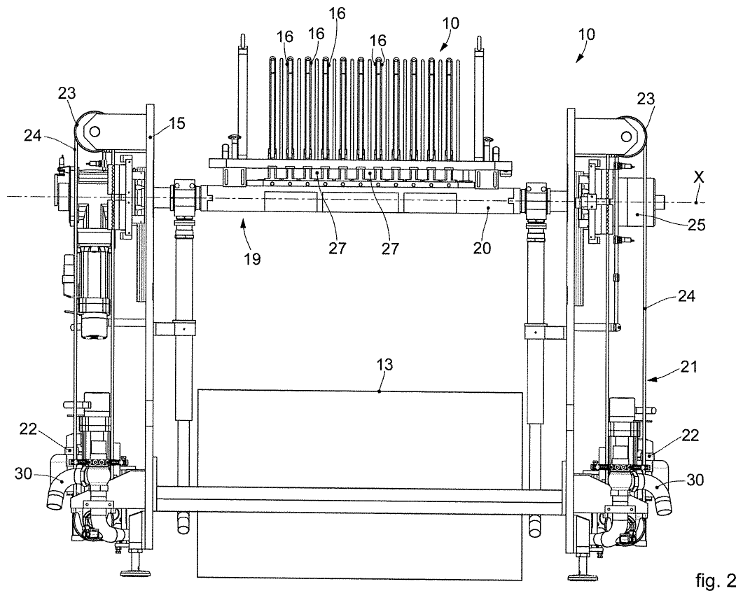

The receiving means can comprise a horizontal conveyor belt 13 underneath, shown schematically in FIG. 2.

In a preferred embodiment, the receiving means comprise one or more trays 13 or holders (FIGS. 7-9) which can be provided with one or more seatings 14 for housing the containers 11. It is intended that the receiving means 13 can also comprise any other support means equivalent to trays, provided it is able to contain the containers 11 in a controlled manner to prevent them from being only rested on the conveyor belt, in a completely free manner.

While the containers 11 can be of any known type or that will be developed hereafter, so that they can be, for example, ramekins, cups, or tubs, in their most various shapes and sizes, cylindrical, truncated cone, parallelepiped, or otherwise, and can be made of any non-rigid material, such as for example paper, with one or more sheets, cardboard, plastic or silicone materials, in the example described here the containers 11 are ramekins, truncated cone-shaped flared toward the outside (FIGS. 4 to 9), that is, with the bottom having a diameter smaller than that of the upper part.

The loading store 12 is mounted on the upper part of a fixed frame 15 (FIG. 1) and comprises a plurality of vertical loading cylinders 16, in this case thirty-three, disposed on three parallel rows, and in each of which a stack of containers 11 can be inserted with their bottom facing upwards (FIGS. 4, 5 and 6).

Each loading cylinder 16 has an internal diameter much larger than the maximum diameter of each container 11 and has a flared lower surface 17. In this way, each stack formed by the containers 11 can slide freely inside the corresponding loading cylinder 16, thrust downward through gravity against the lower surface 17, against which the container 11 that is at the bottom of the stack temporarily rests. Furthermore, each loading cylinder 16 is provided with a lower central aperture 18 having a diameter at least slightly bigger than the diameter of the bottom of each container 11.

On the frame 15, between the loading store 12 and the conveyor belt 13, a pickup device 19 (FIGS. 2 to 9) is mounted, configured to pick up the containers 11 from the lower part of the corresponding loading cylinders 16 and position them in the seatings 14 (FIGS. 7, 8 and 9).

The pickup device 19 comprises a horizontal shaft 20 (FIGS. 2 to 9) having a central cavity 33 coaxial to its axis of rotation X and mounted rotatably on the upper part of a vertical movement unit 21 (FIG. 2). The latter in turn comprises two electric motors 22 disposed on opposite sides of the frame 15 and connected to the shaft 20 by means of pulleys 23 and corresponding toothed belts 24.

According to a variant, not shown in the drawings, but easily understood by the person of skill, the vertical movement unit 21 is commanded, instead of by the electric motors 22, by one or more fluid-dynamic devices which can be, for example, pneumatic, oil-dynamic or hydrodynamic, of a known type.

A third electric motor 25 (FIGS. 1 and 2) is mounted coaxial to the axis of rotation X and is connected to the shaft 20 to make it selectively rotate, as will be described in detail hereafter.

In some embodiments, the electric motors 22 and/or the third electric motor 25 comprise respective position transducers or encoders of a known type, to know the position and orientation of the elements driven by them.

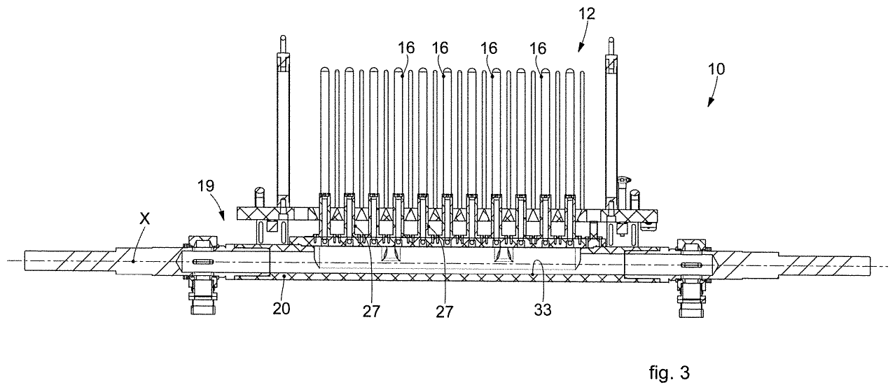

A plurality of pickup elements 27 are removably mounted on the shaft 20, for example by means of screws 26 (FIGS. 3 to 9), the number of which is equal to that of the loading cylinders 16, which is, in the example provided here, thirty-three. The disposition of the pickup elements 27 on the shaft 20 is also equal to and corresponding to that of the loading cylinders 16.

Each pickup element 27 comprises a cylinder 28 (FIGS. 4 to 9), the external diameter of which is slightly less than the diameter of the lower central aperture 18 of the corresponding loading cylinder 16.

Each cylinder 28 comprises an internal cavity 32 that develops axially along the longitudinal direction of the cylinder itself.

Furthermore, each cylinder 28, at least near its distal part, is provided with one or more orifices 29, upper and/or lateral, which put its internal cavity 32 into communication with the outside. The internal cavity 32 of each cylinder 28 is also in communication with the central cavity 33 of the shaft 20, which in turn is connected to a suction and blowing device 30 (FIGS. 1 and 2) of a known type, so that it is selectively possible to aspirate air through the orifices 29, thus creating a depression, or to blow air as will be described in detail hereafter.

The distal part of each cylinder 28 is also provided with a hollow 31 to facilitate the adherence to it of a container 11 to be picked up.

The method for unstacking the containers 11 loaded in the loading store 12 and stacked one above the other in the respective loading cylinders 16, that is, to pick them up individually from the bottom and then position them in the seatings 14, using the machine 10 described here, is as follows.

In particular, with reference to FIGS. 4 to 9, we will now describe a single operating cycle, which will then be repeated, in the same way, at a very high frequency, for example up to 35 cycles/minute, thus conferring on the machine 10 a high productivity per hour.

It should be noted that FIGS. 4-9 show two stacks of containers 11 having a slightly different shape.

The machine 10 according to the invention, and the corresponding method, can also advantageously unstack, using the same pickup device 19, containers 11 having slightly different shapes, as in the case shown.

It is obvious that, in other embodiments, the machine 10 can operate with the loading means 16 which are all filled with identical containers 11.

In a first operating position, shown schematically in FIG. 4, containers 11 are stacked inside the loading cylinders 16, with the lowest container 11 of each stack resting, due to gravity, on the corresponding lower surface 17, while the pickup device 19 is located with the cylinders 28 facing upward, that is, toward the containers 11 to be picked up, and slightly distant from the lower part of the loading cylinders 16.

There is then a pickup step, which comprises a first operating or lifting step, in which the vertical movement unit 21 is driven, by suitably commanding the two electric motors 22, so that the pickup device 19 is lifted and taken from the first operating position to a second operating position, shown schematically in FIG. 5. The control of the electric motors 22 can be carried out at a constant speed, or in such a way that the first segment of the upward vertical travel (arrow F1) of the pickup device 19 takes place at a relatively high speed, while the last segment of the travel takes place at a lower speed.

In this second operating position, pickup elements 27 have partly entered into the loading cylinders 16 through the lower apertures 18 and have lifted by a few millimeters all the stacks of containers 11, thus sufficiently detaching the container 11 at the bottom of each stack from the corresponding lower surface 17.

The first operating lifting step is very advantageous because it allows to align vertically all the containers 11 that are temporarily located at the bottom of the different stacks. This is useful because the containers 11 are of a non-rigid type and therefore due to the flexibility of the material of which they are made, they could be positioned at different heights inside the loading cylinder 16. Consequently, without the first operating lifting step, in some loading cylinders 16, the pickup element 27 might not come into contact with the container 11 temporarily located at the bottom of the stack. In this case, this container 11 may not be temporarily constrained to the respective pickup element 27 but on the contrary remain at the bottom of the stack inside the loading cylinder 16. Keeping the pickup device 19 in said second operating position, a second operating or suction step is carried out in which the suction and blowing device 30 is driven so that air is aspirated through the orifices 29 of each pickup element 27 and that the corresponding container 11 is thus sucked toward the external surface, both the head surface and the cylindrical surface, of the cylinder 28 of the same pickup element 27. It should be noted that, thanks to the suction step, the bottom of the container 11 deforms, as indicated schematically by a line of dashes in FIG. 5, but leaving the lateral walls non-deformed.

Since now each container 11, which was located at the bottom of the corresponding stack, is temporarily constrained to the corresponding pickup element 27, by means of air suction, a third operating or removal step is then performed, in which the vertical movement unit 21 is again driven, suitably commanding the two electric motors 22 in the opposite direction, so that the pickup device 19 is now lowered (arrow F2) and is returned to the initial first operating position, shown schematically in FIG. 6. Consequently, all the stacks of containers 11 inside the loading cylinders 16 will go downward through gravity, until another container 11, which is now at the bottom of the stack, will stop against the corresponding lower surface 17.

After the pickup step described above, a step of positioning the containers 11 picked up in the seatings 14 of the conveyor belt 13 is performed. The positioning step comprises a fourth operating or rotational step in which, by keeping the containers 11 in contact with the cylinders 28 of the pickup elements 27, by means of air suction, the third electric motor 25 is driven so as to make the shaft 20 and all the pickup elements 27 and the containers 11 associated with them perform a rotation of about 180° around the axis of rotation X, thus taking the pickup device 19 into a third operating position, shown schematically in FIG. 7.

A fifth operating or insertion step is then carried out, in which the vertical movement unit 21 is again driven, suitably commanding the two electric motors 22 so that the pickup device 19 is further lowered (arrow F3) until it is taken to a fourth operating position, shown schematically in FIG. 8, in which the containers 11 associated with the pickup elements 27 are inserted into the corresponding seatings 14 of the conveyor belt 13. In this case too, the control of the electric motors 22 can take place at constant speed, or so that the first segment of the vertical downward travel of the pickup device 19 takes place at a relatively high speed, while the last segment of the travel takes place at a lower speed.

As soon as the fourth operating position is reached, a sixth operating or blowing step is performed in which the suction and blowing device 30 is driven to blow air through the orifices 29 and thus detach the containers 11 from the corresponding pickup elements 27.

In a variant, the fourth operating position of the pickup device 19 is an intermediate position between those shown in FIGS. 7 and 8. In other words, in the fourth operating position, the pickup elements 27 do not penetrate inside the seatings 14 but remain slightly distanced from them in the vertical direction. In this variant, the sixth operating or blowing step allows the containers 11 to fall due to gravity into a respective seating 14.

It should be noted that this configuration is advantageously obtainable with a pickup device 19 like the one described above, which allows to deform only the bottom wall of the containers 11, while the lateral walls thereof remain non-deformed. However, once the containers 11 have been filled with a product, their bottom wall can again take the flat shape independently, thanks to the action of the weight force that is exerted by the product itself. At this point, after the containers 11 have naturally retaken their initial shape, also thanks to the elasticity of the material of which they are made, and are inserted precisely in the seatings 14, a seventh operating or realignment step is performed in which the vertical movement unit 21 is again driven, suitably commanding the two electric motors 22 so that the pickup device 19 is lifted again (arrow F4) until it is returned to said third operating position, shown schematically in FIG. 9.

Finally, an eighth or final step is performed, which can be immediately after the previous one, or can be considered as a second part of the previous one, in which the pickup device 19, suitably commanding both the third electric motor 25 and also the two electric motors 22, by means of a rotation of about 180° of the shaft 20 around its axis of rotation X and a translation parallel to the latter, is returned to its initial position, which corresponds to said first operating position, shown schematically in FIG. 4.

At the same time, the receiving means 13 are made to suitably advance so that other seatings 14 are positioned correctly below the pickup device 19 to receive other containers 11.

Other new cycles can then be performed, in the manner described above.

It should be noted that, thanks to the fact that the motors 22, 25 are provided with respective encoders, the machine for unstacking containers according to the invention can be controlled and commanded in a very simple way, by adjusting the operating parameters (pickup device travel/cycle time) depending on the shape and number of containers to be unstacked and possibly also depending on the type of receiving means 13 to be used.

In one embodiment, the control and management unit of the machine allows to associate a different set of operating parameters to each shape/type of container 11. In this way, whenever the operator has to prepare the machine 10 to work on a different type of container 11, he only has to select from a control panel the format of containers 11 that has to be worked and the machine 10 is immediately prepared for the new working. Thanks to this, the machine 10 according to the invention has extremely short set-up times and allows to manage the change-of-format of the containers 11 quickly and accurately without the need for any long and laborious manual re-programming. It should be noted that the machine 10 as described heretofore is very versatile and can be easily adapted without any complicated or complex operation, depending on the different shapes and/or sizes of the containers 11.

In fact, it is sufficient to replace the loading cylinders 16 to adapt them to the new format of the containers 11, as well as the pickup elements 27, thanks to the fact that they can be removed from the shaft 28 without altering the rest of the machine 10.

Furthermore, the removability of the pickup elements 27 allows them to be replaced, even individually, in a quick and easy way, in the event of wear or breakage.

In a variant, not shown, the machine 10 can comprise two fixed semi-frames 15, identical to each other, disposed on opposite sides with respect to the receiving means, that is, the conveyor belt 13, and consequently two pickup devices 19. This is useful, in particular, if the conveyor belt 13 has a very big amplitude (in a direction parallel to the axis X), for example three meters. In this case, it is obvious that making a single frame 15, a single pickup device 19 and a single vertical movement unit 21 can cause the elements and components comprised in the machine 10 (for example, the shaft 20 carrying the pickup elements 27) to have excessive sizes and weights that make them extremely costly and complicated to move.

It is clear that modifications and/or additions of parts may be made to the machine 10 for unstacking containers, preferably non-rigid, and configured to contain food products, and the corresponding method as described heretofore, without departing from the field and scope of the present invention.

It is also clear that, although the present invention has been described with reference to some specific examples, a person of skill in the art shall certainly be able to achieve many other equivalent forms of machines and corresponding methods for unstacking containers, preferably non-rigid, and configured to contain food products, having the characteristics as set forth in the claims and hence all coming within the field of protection defined thereby.

1. A machine for unstacking containers configured to contain food products, comprising loading means configured to contain inside them said containers stacked one on top of another, with their bottom facing upward, and receiving means configured to receive said containers after they have been picked up from said loading means, and further comprising pickup means disposed between said loading means and said receiving means and configured to move vertically at least between a first operating position, in which said pickup means are facing toward said containers but distant from them, and a second operating position in which said pickup means are at least partly inserted in said loading means and in contact with each of said containers that is temporarily at the bottom of the corresponding stack, and vice versa, first movement means configured to selectively move said pickup means at least between two operating positions, suction means associated with said pickup means and configured to be activated when said pickup means are in said second operating position in order to temporarily constrain to said pickup means, by means of air suction, each of said containers that is temporarily at the bottom of the corresponding stack, and second movement means configured to take said pickup means from said first operating position to a third operating position, in which they are rotated by about 180° and facing toward said receiving means in order to position on the latter said containers picked up from said loading means by means of said pickup means.

2. The machine as in claim 1, wherein said loading means comprise a determinate number of loading cylinders, substantially vertical and with a determinate spatial disposition, and in that said pickup means comprise a number of pickup elements equal to the number of said loading means and with the same spatial disposition as the latter.

3. The machine as in claim 2, wherein said containers have a truncated cone shape flared toward the outside, wherein each of said loading cylinders has an internal diameter bigger than the maximum diameter of each of said containers and is provided both with a flared lower surface, against which the container that is at the bottom of the stack can temporarily rest, and also with a lower central aperture with a diameter at least slightly bigger than the diameter of the bottom of each of said containers.

4. The machine as in claim 3, wherein each of said pickup elements comprises a cylinder provided with an internal cavity in fluidic communication with said suction means.

5. The machine as in claim 4, wherein each of said cylinders has an external diameter slightly smaller than the diameter of said lower central aperture of the corresponding loading cylinder.

6. The machine as in claim 4, wherein each of said cylinders is provided with one or more upper and/or lateral orifices, which put said internal cavity of each of said cylinders into communication with ambient.

7. The machine as in claim 4, wherein each of said cylinders comprises a hollow on its distal part.

8. The machine as in claim 1, wherein each of said pickup elements is removably assembled on a shaft connected both to said first movement means and also to said second movement means.

9. The machine as in claim 1, wherein said first movement means comprise at least an electric motor, and in that said second movement means comprises another electric motor.

10. A method for unsticking containers, configured to contain food products, by means of a machine with loading means configured to contain inside them said containers stacked one on top of the other, with their bottom facing upward, and receiving means configured to receive said containers after they have been picked up from said loading means, comprising raising vertically pickup means disposed between said loading means and said receiving means by first movement means from a first operating position, in which said pickup means are facing toward said containers but distant from them, to a second operating position in which said pickup means are at least partly inserted in said loading means and in contact with each of said containers that is temporarily at the bottom of the corresponding stack, actvating suction means associated with said pickup means to temporarily constrain to said pickup means, by means of air suction, each of said containers that is temporarily at the bottom of the corresponding stack, and returing said pickup means to said first operating position together with the containers associated therewith by said suction means that remain activated, and a positioning said pickup means with second movement means from said first operating position to a third operating position, in which said pickup means are rotated by about 180° and facing toward said receiving means in order to position on the latter said containers picked up from said loading means by means of said pickup means.

11. A method as in claim 10, wherein said positioning step comprises a blowing with blowing means, by means of said pickup means, air toward the corresponding containers associated with the said pickup means in order to detach the corresponding containers from said pickup means.
